(19) United States
(12) Patent Application Publication
(10) Pub. No.: US 2018/0198138 A1
(43) Pub. Date: Jul. 12, 2018

(54) FUEL CELL DEVICE HAVING A FUEL CELL STACK INCLUDING A THERMALLY INSULATED CONTAINER AND METHOD FOR OPERATING A FUEL CELL DEVICE

(71) Applicant: Volkswagen AG, Wolfsburg (DE)

(72) Inventors: Peter Bach, Burnaby (CA); Ryan Paddon, Burnaby (CA); Mark Hollett, Burnaby (CA); Robert Croft, Burnaby (CA)

(21) Appl. No.: 15/322,185

(22) PCT Filed: Jun. 4, 2015
(86) PCT No.: PCT/EP2015/062528

§ 371 Date: Dec. 27, 2016

(30) Foreign Application Priority Data
Jun. 27, 2014 (DE) DE102014212495.6

(51) Int. Cl. H01M 8/04029; H01M 8/04007; H01M 8/04223; H01M 8/04701

(52) U.S. Cl. CPC H01M 8/04029; H01M 8/04052; F28D 2021/0043; H01M 8/04268; H01M 8/04731; H01M 8/04067

(57) ABSTRACT

A fuel cell device and a method for operating a fuel cell device is provided. In order to be able to efficiently heat a fuel cell device during a cold start, a fuel cell stack (1) of the fuel cell device includes a thermally insulated container (5) for temperature control fluid, and the temperature control fluid is conducted from the thermally insulated container (5) into at least one fuel cell (2) of the fuel cell stack (1) when the fuel cell device is started.

The present invention relates to a fuel cell device having a fuel cell stack, which includes at least one fuel cell situated between two end plates. Furthermore, the invention relates to a method for operating a fuel cell device, in which the fuel cell device is temperature controlled using a temperature control fluid.

### BACKGROUND

Fuel cell devices and methods for operating fuel cell devices are generally known. In the case of a cold start of the fuel cell device, i.e., when it has a temperature upon starting which is below an optimum operating temperature range, known fuel cell devices are heated by waste heat generated by the at least one fuel cell, until the operating temperature of the fuel cell device is within the optimum operating temperature range. However, heating a fuel cell device with the aid of the waste heat of the fuel cells may take a very long time in particular in the case of a low load. Therefore, heating of the fuel cell device with the aid of a heating element during starting is known. The energy required by the heating element may be provided by the fuel cell device. However, energy provided for the heating element is no longer available for other consumers connected to the fuel cell device. Furthermore, the consumption of operating media of the fuel cell device increases.

### SUMMARY OF THE INVENTION

It is an object of the present invention to provide a fuel cell device and a method for operating a fuel cell device, whereby the fuel cell device may be heated up rapidly and efficiently in the event of a cold start.

The present invention provides for the fuel cell device mentioned at the outset that the fuel cell stack includes a thermally insulated container for a temperature control fluid for the temperature control of the fuel cell device. The present invention also provides for the method mentioned at the outset that the temperature control fluid, which has residual heat from previous operation of the fuel cell device, is used during a starting procedure of the fuel cell device for heating the fuel cell device.

Because the heated temperature control fluid is provided in the thermally insulated container, its temperature only decreases slowly in comparison to the fuel cell stack, so that during a normal operating cycle of the fuel cell device, there is a sufficient quantity of heat in the temperature control fluid contained in the thermally insulated container for accelerated heating of the fuel cell stack. The temperature control fluid is a water-alcohol mixture, in particular. The fuel cell device does not need to provide energy solely for heating the fuel cell stack during starting, so that the energy which may be provided by the fuel cell device during starting is available to external consumers of the fuel cell device.

The present invention may be further improved by various embodiments, which are each advantageous per se and, if not otherwise indicated, may be arbitrarily combined with one another. These embodiments and the advantages linked thereto will be described hereafter.

The thermally insulated container may be attached to one of the end plates. In this way, the fuel cell stack may be designed compactly, and long lines are not required between the thermally insulated container and the fuel cell stack. During the transport through long lines, the temperature control fluid could emit heat and therefore will not heat the fuel cell stack sufficiently or will do so more slowly than otherwise during starting. Thermally insulated lines are costly and require even more installation space than normal long lines.

The fuel cells are often clamped between the end plates, so that a high pressure prevails on the fuel cells between the end plates. If the thermally insulated container is formed sufficiently stably, it may be situated like the at least one fuel cell between the end plates and clamped thereby. If the thermally insulated container is not able to permanently withstand the forces acting within the fuel cell stack or if a thermally insulated container which may withstand these forces is excessively heavy, the end plate on which the thermally insulated container is attached may be situated between the thermally insulated container and the at least one fuel cell. The thermally insulated container is thus preferably not situated between the end plates, so that the forces acting on the at least one fuel cell do not act on the thermally insulated container.

In order that the fuel cell stack may be constructed compactly and may be installed easily in the fuel cell device, the end plate on which the thermally insulated container is attached may connect the thermally insulated container and the at least one fuel cell to one another in a temperature control fluid conducting manner. For example, the end plate may include at least one temperature control fluid tunnel, which connects the thermally insulated container to the at least one fuel cell in a fluid conducting manner.

Fuel cell devices often include a temperature control path for conducting the temperature control fluid and for the temperature control of the fuel cells. In particular, the temperature control path may extend through the at least one fuel cell, so that the temperature control fluid conducted through the temperature control path may exchange heat with the at least one fuel cell. In addition, the temperature control path may extend through the thermally insulated container, so that a separately formed temperature control path is not necessary.

If the thermal insulation of the thermally insulated container is not sufficient to prevent the temperature of the temperature control fluid situated in the thermally insulated container from sinking excessively strongly during a shutdown of the fuel cell device or if the fuel cell device remains shut down over a long period of time, the thermally insulated container may include a heating element, using which the temperature control fluid situated in the thermally insulated container may be heated. The temperature control fluid may be heated particularly efficiently using the heating element if the heating element is situated in a free volume for the temperature control fluid and therefore may contact the temperature control fluid directly. In particular, the temperature control fluid may be heated in particular during the shutdown of the fuel cell device, to prevent sinking of the temperature of the temperature control fluid situated in the thermally insulated container below a predetermined minimum temperature. For example, the predetermined minimum temperature is 40° C. With thermally insulated containers which are thermally insulated well, the temperature control fluid in the thermally insulated container, without requiring a large amount of power, may be kept at the minimum temperature, for example, 40° C., even if the ambient temperature is low and is −28° C., for example. Since only 5 W of electrical power are required for heating the temperature control fluid, the temperature of the temperature control fluid in the thermally insulated container may readily be kept at or above the minimum temperature over a long period of time and, for example, for several days. The electrical power may be provided by the fuel cell device for a storage unit, which stores electrical power and receives electrical power from the fuel cell device during the operation thereof, for example, a rechargeable battery or a capacitor.

In order that the temperature control fluid may be conveyed from the thermally insulated container to the fuel cells, the fuel cell device may include a temperature control fluid pump, which connects the thermally insulated container to the fuel cells which conducts temperature control fluid conducting manner. In particular, temperature control fluid may be conveyed using the temperature control fluid pump between the thermally insulated container and the fuel cell. The temperature control fluid pump is, for example, situated in the thermally insulated container or in or on the end plate, on which the thermally insulated container is attached. For example, the temperature control fluid pump may be situated in the temperature control fluid tunnel, so that the installation space required for the fuel cell stack is not increased. The temperature control fluid pump is preferably a separately provided pump, the fuel cell device being able to include a further temperature control fluid pump for the temperature control fluid, which conveys temperature control fluid through the temperature control path during normal operation of the temperature control fluid pump.

To prevent the preheated temperature control fluid, which is to be stored in the thermally insulated container, from unintentionally running out of it or mixing with colder temperature control fluid in the thermally insulated container, the fuel cell device may include at least one shutoff valve, using which a temperature control fluid stream between the thermally insulated container and the fuel cell is interruptible. The thermally insulated container may be disconnectable from the remaining temperature control path using the shutoff valve, for example. In particular, the volume enclosed by the thermally insulated container may be disconnectable from the remaining temperature control path using the at least one shutoff valve. The shutoff valve is arranged, for example, in or on the end plate fastened on the thermally insulated container and, for example, in the temperature control fluid channel extending through the end plate, so that the installation space required by the fuel cell device is not increased by the at least one shutoff valve.

In order that the temperature control fluid may flow readily into the thermally insulated container, this container may have an inlet opening and an outlet opening, so that the temperature control path may extend into the thermally insulated container and back out of it again, without the temperature control path overlapping with itself. The temperature control fluid may therefore flow easily into the thermally insulated container, through it, and/or out of it.

The residual heat, in particular from waste heat of the fuel cell device, may be withdrawn from the temperature control fluid.

In particular, prior to a starting procedure of the fuel cell device, the temperature control fluid having the residual heat may be supplied with additional heat, if its temperature is less than the predefined minimum temperature. Fuel cell devices are often put into operation in regularly repeating time intervals, so that the temperature of the temperature control fluid may be increased automatically when a repeating starting procedure approaches. For example, motor vehicles which are drivable at least partially using the electrical power provided by the fuel cell device are regularly put into operation in the morning on weekdays, to drive to work using the motor vehicle. Stationary fuel cell devices, which provide electrical power for apartment buildings or industrial or office buildings, for example, are also often put into operation in the morning. When carrying out the method according to the present invention, a temperature control fluid contained in the at least one fuel cell of the fuel cell stack of the fuel cell device may be replaced at least partially by the temperature control fluid having the residual heat, in order to preheat the at least one fuel cell. For this purpose, for example, a volume provided for the temperature control fluid in the thermally insulated container may essentially correspond to the volume of the temperature control path between the end plates, i.e., on and/or in the fuel cells, or may be greater than this volume, so that temperature control fluid contained inside the fuel cells may be replaced by the temperature control fluid which the thermally insulated container may accommodate.

### BRIEF DESCRIPTION OF THE DRAWINGS

The present invention is explained hereafter in exemplary embodiments on the basis of the drawings.

FIG. 1 shows a schematic representation of an exemplary embodiment of a fuel cell device according to the present invention,

FIG. 2 shows a schematic representation of a method according to the present invention for operating a fuel cell device.

### DETAILED DESCRIPTION

The present invention is explained hereafter by way of example on the basis of specific embodiments with reference to the drawings. The different features of the specific embodiments may be combined independently of one another, as has already been described in the individual advantageous embodiments.

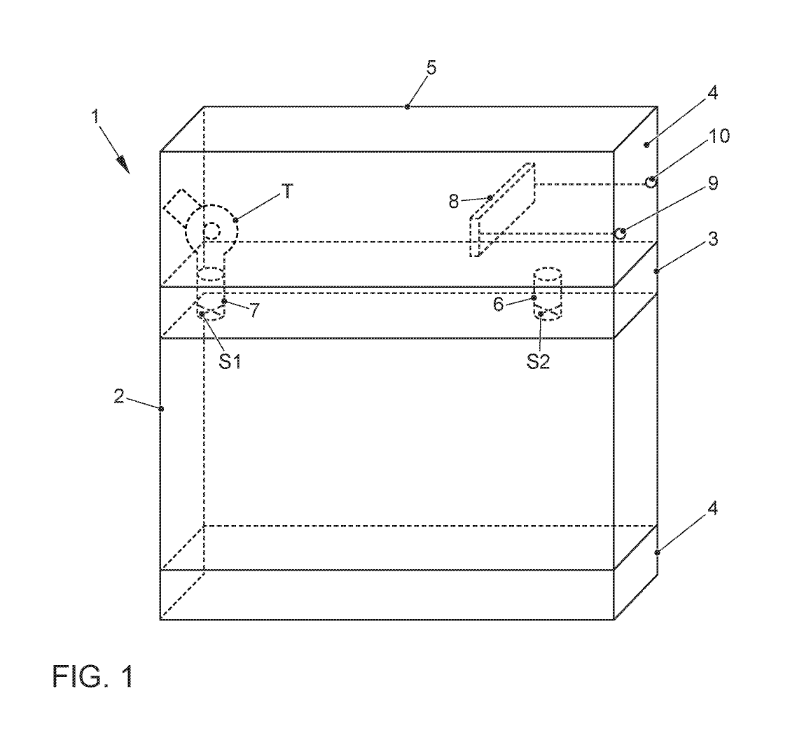

Firstly, the structure and function of a fuel cell device according to the present invention will be described with reference to the exemplary embodiment of FIG. 1.

FIG. 1 schematically shows a fuel cell stack 1 of the fuel cell device according to the present invention in a perspective representation. Fuel cell stack 1 includes at least one and in particular multiple fuel cells 2, which are situated between two end plates 3, 4 of fuel cell stack 1 and are clamped and/or compressed, for example. The at least one fuel cell 2 may include two bipolar plates and at least one so-called membrane electrode unit. The bipolar plates may conduct operating media, such as hydrogen and air, to the membrane electrode unit, where the operating media react with one another to generate electrical power. Furthermore, the bipolar plates may conduct a temperature control fluid past the membrane electrode unit and in particular through fuel cell 2, to control the temperature of fuel cell 2.

The fuel cell stack furthermore includes a thermally insulated container 5, in which a temperature control fluid for the temperature control of the fuel cell device is storable. For example, thermally insulated container 5 is attached or fastened on end plate 3, end plate 3 preferably being situated between the at least one fuel cell 2 and thermally insulated container 5. A pressure, which prevails between end plates 3, 4 and acts on the at least one fuel cell 2, is thus not conducted to thermally insulated container 5.

In order that the temperature control fluid conducted through the at least one fuel cell 2 during operation may be conducted into thermally insulated container 5, without the installation space required for fuel cell stack 1 increasing, end plate 3 has at least one temperature control tunnel 6. Temperature control tunnel 6 connects the at least one fuel cell 2 to thermally insulated container 5 in a temperature control fluid conducting manner. Thermally insulated container 5 is preferably connected by temperature control tunnel 6 to a temperature control path which extends through the at least one fuel cell 2, so that temperature control fluid which flows through the temperature control path during operation of the fuel cell device may flow into thermally insulated container 5.

In order that the temperature control fluid is able to flow through thermally insulated container 5, end plate 3 has not only one, but two temperature control tunnels 6, 7, for example, temperature control fluid being able to flow into thermally insulated container 5 through temperature control tunnel 6 and being able to flow out of thermally insulated container 5 through temperature control tunnel 7. The temperature control path may thus extend not only through the at least one fuel cell 2, but rather furthermore also through thermally insulated container 5.

The temperature control path may include two lines extending in a stack direction of the bipolar plates and the membrane electrode unit, through which the temperature control fluid may flow. One of the lines may extend in an edge area of the bipolar plates and may open, for example, into temperature control tunnel 6. The other of the lines may extend in another edge area, which is opposite to the mentioned edge area in particular, of the bipolar plates, and temperature control tunnel 7 may open into this line. The at least one fuel cell may thus be fluidically connected in parallel to thermally insulated container 5. A section of the temperature control path, which leads along one of the bipolar plates and connects the lines to one another in a fluid conducting manner, may extend in parallel to thermally insulated container 5.

A heating element 8 may be situated in thermally insulated container 5 to supply the temperature control fluid situated in thermally insulated container 5 with thermal energy. Above all when the fuel cell device is not in operation, heating element 8 may therefore keep the temperature control fluid situated in thermally insulated container 5 at least at a minimum temperature.

Terminal contacts 9, 10 of heating element 8 may be led through a side wall 11 of thermally insulated container 5 and may be contacted from outside thermally insulated container 5. Heating element 8 may be connectable or connected via terminal contacts 9, 10 to a source of electrical power, for example, a battery or a capacitor, the source of electrical power being able to be part of the fuel cell device or provided separately.

Fuel cell stack 1 may furthermore include a temperature control fluid pump T and/or at least one shutoff valve S1, S2, to be able to convey the temperature control fluid located in thermally insulated container 5 out of the container or to be able to store it therein separately from the remaining temperature control path. Temperature control fluid pump T may be situated in thermally insulated container 5 and may be connected, for example, to one of temperature control tunnels 6, 7, for example, temperature control tunnel 7. The at least one shutoff valve S1, S2 is situated, for example, so that it may block one of temperature control tunnels 6, 7 and therefore prevent a flow of the temperature control fluid through blocked temperature control tunnel 6, 7. Each of temperature control tunnels 6, 7 is preferably blockable or closable by a shutoff valve S1, S2.

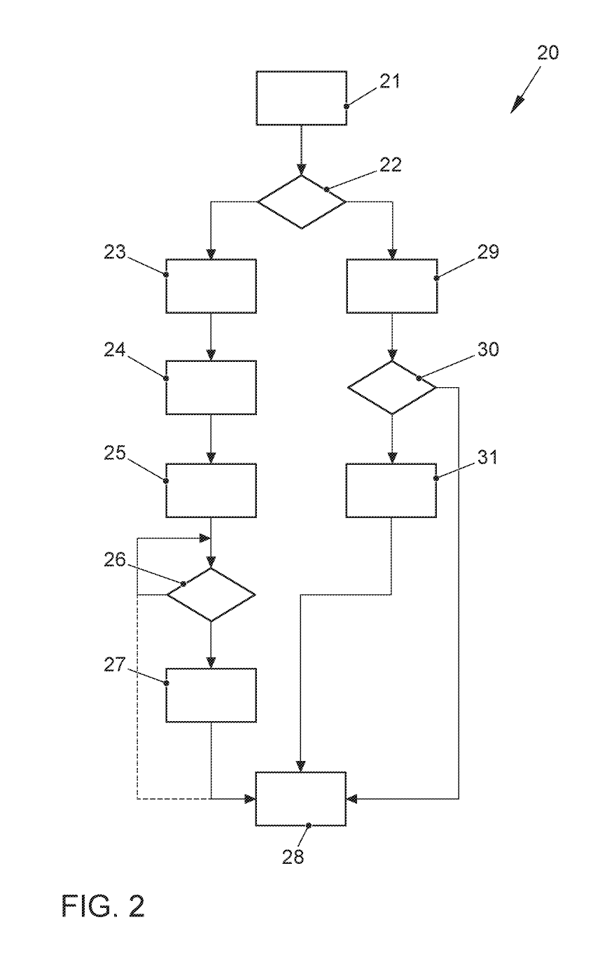

FIG. 2 schematically shows a first exemplary embodiment of the method according to the present invention for operating a fuel cell device as a flow chart. For elements of the fuel cell device, which are mentioned hereafter for the description by way of example of the method according to the present invention, the same reference numerals are used as in the exemplary embodiment of FIG. 1.

Method 20 of the exemplary embodiment of FIG. 2 starts with a first method step 21. In the following method step 22, it is ascertained whether the fuel cell device is in operation or out of operation. If the fuel cell device is in operation, method step 23, in which temperature control fluid, which contains heat emitted by the at least one fuel cell 2, is conducted into thermally insulated container 5, may follow method step 22. The temperature control fluid may flow continuously through thermally insulated container 5 during operation of the fuel cell device.

If the fuel cell device is taken out of operation in the following method step 24, in next method step 25, thermally insulated container 5 may be disconnected from the remaining temperature control path and may be closed, for example, with the aid of the at least one shutoff valve. Before the disconnection or closing of thermally insulated container 5, in method step 25, temperature control fluid may be conducted from the at least one fuel cell 2 into thermally insulated container 5, so that it contains temperature control fluid having residual heat, even if, during operation of the fuel cell device, the temperature control fluid does not flow through thermally insulated container 5 and, for example, only flows through the at least one fuel cell 2.

If thermally insulated container 5 is closed, the temperature of the temperature control fluid may be measured and, for example, monitored in the optionally following method step 26. The temperature may be measured or monitored, for example, at predefined time intervals, at previously determined points in time, or continuously. If the temperature of the temperature control fluid is less than a predefined minimum temperature, method step 27, in which thermal energy is supplied to the temperature control fluid, may thus follow method step 26. For this purpose, the temperature control fluid is heated using heating element 8, for example. If the temperature of the temperature control fluid is greater than the predetermined minimum temperature, method step 26 may thus be repeated or method step 28, in which method 20 ends and, for example, the sequence waits for a restart of the fuel cell device, may follow method step 26.

If it is determined in method step 22 that the fuel cell device is not in operation or is taken out of operation, the fuel cell device may be put into operation in method step 29. For example, in the event of an approaching start of a consumer to be supplied with electrical power by the fuel cell device, the fuel cell device may be put into operation automatically or manually.

In the following method step 30, the temperature of the temperature control fluid present in thermally insulated container 5 and optionally the temperature of the fuel cell device is determined. If the temperature of the fuel cell device and in particular of fuel cell stack 1 is less than an optimal operating temperature and the temperature of the temperature control fluid in thermally insulated container 5 is less than a minimum temperature, method step 31, in which the temperature control fluid in thermally insulated container 5 is heated, for example, using heating element 8, may thus follow method step 30. If the temperature of the temperature control fluid has reached the minimum temperature, method 20 may end in method step 28, in that the at least one fuel cell 2 is heated using the temperature control fluid from thermally insulated container 5 and this fluid is conducted for this purpose from thermally insulated container 5 into the at least one fuel cell 2.

If it is determined in method step 30 that the temperature of the temperature control fluid corresponds to the minimum temperature or is greater than the minimum temperature, method step 28 may follow method step 30 and the at least one fuel cell 2 may be heated using the temperature control fluid from thermally insulated container 5 and this fluid may be conducted for this purpose from thermally insulated container 5 into the at least one fuel cell 2.

For example, it may be unnecessary to heat up the temperature control fluid in method step 30, if it is still sufficiently warm despite the storage in thermally insulated container 5 or if sufficient heat was already supplied to it during storage.

### LIST OF REFERENCE SIGNS

1 fuel cell stack
2 fuel cell
3, 4 end plate
5 thermally insulated container
6, 7 temperature control tunnel
8 heating elements
9, 10 terminal contacts of the heating element
11 side wall of the thermally insulated container
20 method
21 start
22 fuel cell device in operation?
23 conduct temperature control fluid into thermally insulated container
24 take fuel cell device out of operation
25 close thermally insulated container
26 measure temperature of the temperature control fluid
27 supply thermal energy to the temperature control fluid
28 end (conduct temperature control fluid to the fuel cell)
29 put fuel cell device into operation
30 measure temperature of the temperature control fluid
31 heat up temperature control fluid
S1, S2 shutoff valve
T temperature control fluid pump

1-10. (canceled)

11: A fuel cell device comprising:
a fuel cell stack including at least one fuel cell situated between two end plates, the fuel cell stack including a thermally insulated container for a temperature control fluid for temperature control of the fuel cell device.

12: The fuel cell device as recited in claim 11 wherein the thermally insulated container is attached to one of the end plates.

13: The fuel cell device as recited in claim 12 wherein the one end plate is situated between the thermally insulated container and the at least one fuel cell.

14: The fuel cell device as recited in claim 12 wherein the one end plate connects the thermally insulated container and the at least one fuel cell to one another in a temperature control fluid conducting manner.

15: The fuel cell device as recited in claim 11 further comprising a temperature control path for conducting a temperature control fluid and for controlling the temperature of the at least one fuel cell, the temperature control path extending through the thermally insulated container.

16: The fuel cell device as recited in claim 11 further comprising at least one shutoff valve, a temperature control fluid stream between the thermally insulated container and the fuel cell being interruptible via the shutoff valve, or further comprising a temperature control fluid pump, temperature control fluid conveyable between the thermally insulated container and the fuel cell via the temperature control fluid pump.

17: A method for operating a fuel cell device temperature controlled using a temperature control fluid, the method comprising:
using, during a starting procedure of the fuel cell device, a temperature control fluid having residual heat from previous operation of the fuel cell device, is used for heating the fuel cell device.

18: The method as recited in claim 17 wherein the residual heat from waste heat of the fuel cell device is withdrawn from the temperature control fluid.

19: The method as recited in claim 17 further comprising supplying additional heat to the temperature control fluid prior to the starting procedure of the fuel cell device.

20: The method as recited in claim 17 further comprising at least partially replacing a temperature control fluid contained in at least one fuel cell of a fuel cell stack of the fuel cell device by the temperature control fluid having the residual heat.
